(19) United States
(12) Patent Application Publication
(10) Pub. No.: US 2008/0049767 A1
(43) Pub. Date: Feb. 28, 2008

(54) Method for controlling multiple network services based on a user profile

(75) Inventor: Joyce D. Koltenuk, Flanders, NJ (US)

Correspondence Address: AT&T CORP., ROOM 2A207, ONE AT&T WAY, BEDMINSTER, NJ, 07921, US

(73) Assignee: AT&T Corp.

(21) Appl. No.: 11/510,163

(22) Filed: Aug. 25, 2006

(51) Int. Cl. H04L 12/56

(52) U.S. Cl. 370/401

(57) ABSTRACT

Disclosed is a method and system for controlling multiple network services based on a common user profile. A plurality of user profiles, each specifying access and delivery settings for a plurality of network services, are maintained. When a user uses any of the network services, a login request is received, the user profile associated with that user is accessed, and access to and delivery of all of the network services to the user are controlled based on the user profile. The access settings in the user profile are used to restrict certain content from each of the network services, and the delivery settings are used to specify delivery preferences of the user.

### BACKGROUND OF THE INVENTION

The present invention is generally directed to controlling delivery and access settings for multiple network services. More specifically, the present invention is directed to controlling delivery and access settings for multiple network services delivered to a user using a single user profile associated with the user.

As network technology is developed various network services, such as Internet service, Internet Protocol Television (IPTV), Voice over Internet Protocol (VoIP), network gaming, etc., become available for users. For example, IPTV is a service in which television programming is delivered to consumers via a data network (e.g., the Internet) using Internet Protocol. More particularly, in IPTV, television programming is delivered as video content, which is divided into data packets and streamed to consumers over the Internet. The data packets are received by an IPTV client, such as a set top box, which is connected to a consumer's television. Typically, IPTV clients connect to the Internet over a broadband connection.

IPTV provides greater control and flexibility to consumers than traditional TV distribution technologies. For example, because television programming is delivered point-to-point from a provider to a consumer, a consumer may individually control (i.e., pause, rewind, etc.) programming being delivered. Also, because television programming is being delivered over the Internet, a consumer may receive IPTV programming from around the world. Additionally, IPTV can be provided with other Internet services, such as Voice over IP (VOIP) services and Internet service.

Furthermore, delivery and access settings for IPTV, such as parental controls can be controlled by a user. A user can set parental controls for the IPTV service, which blocks certain channels or programs with certain ratings. However, different parental controls may be required for different users of the same IPTV service. In this case, a user having an authorization code must change the parental controls depending on who is present. Also, other delivery settings such as a preferred channel list are typically set to one user of the IPTV service, even though common preferences may not be shared by all users of the same IPTV service.

When Internet service, VoIP service, etc., are provided to users along with IPTV service, delivery and access settings of these services are each controlled separately. For example, a user with IPTV and Internet service has to set up delivery options and parental controls for IPTV via a television, and separately set up delivery options and parental controls for the Internet service via a personal computer. It is inconvenient for a user to have to set up and keep track of delivery and access settings for multiple services at multiple locations.

### BREIF SUMMARY OF THE INVENTION

The present invention allows a user to control delivery and access settings for multiple network services from a common user profile. Furthermore, the present invention allows multiple users to maintain separate delivery and access settings while sharing network services. This is accomplished using a user profile for each user. The user profile for each user stores access settings and delivery settings of that user for each of the multiple network services available to that user.

In one embodiment of the present invention, a plurality of user profiles, each specifying access and delivery settings for a plurality of network services, are maintained. When a user uses any of the network services, a login request is received, the user profile associated with that user is accessed, and access to and delivery of the plurality of network services to the user are controlled based on the user profile. The access settings in the user profile are used to restrict certain content from each of the network services, and the delivery settings are used to specify delivery preferences of the user. The network services can include such services as IPTV, VoIP, Internet service, network gaming, etc.

Each user profile is associated with a user, and at least one of the users is an administrator. An administrator can set and modify the access settings of the all of the user profiles, and no user who is not an administrator is permitted to modify the access settings. Each user can set and modify the delivery settings of his or her user profile. Accordingly, the present invention can be used in families to provide parental control and in businesses to restrict employee access to certain content. For example, in a family, each family member can set the delivery preferences for multiple network services in his or her own user profile, and a parent can control access of the children to certain content in each of the network services by setting the access settings of the children's user profiles. These parental controls do not need to be repeated or entered on a different device for each network service because all of the network services are controlled through a common user profile.

These and other advantages of the invention will be apparent to those of ordinary skill in the art by reference to the following detailed description and the accompanying drawings.

### BRIEF DESCRIPTION OF THE DRAWINGS

FIG. 1 illustrates an exemplary system configured to implement an embodiment of the present invention;

FIG. 2 illustrates exemplary user profiles;

FIG. 3 illustrates a method of controlling multiple network services based on a user profile according to an embodiment of the present invention; and

FIG. 4 illustrates a high level block diagram of a computer capable of implementing the present invention.

### DETAILED DESCRIPTION

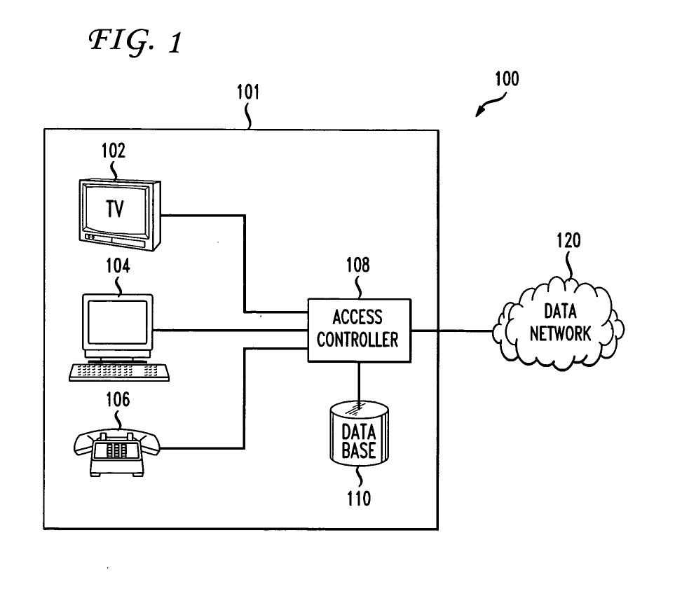

FIG. 1 illustrates an exemplary system 100 configured to implement an embodiment of the present invention. As illustrated in FIG. 1, the system 100 includes customer premises equipment (CPE) 101 communicating with a data network 120, such as the Internet. In this embodiment, the CPE 101 includes a television (TV) 102 which receives IPTV service, a personal computer (PC) 104 which has Internet access, and telephone 106 which receives VoIP service. These devices 102,104, and 106 are used by a group of users, such as a family, business, etc. The PC 104 can be used for various Internet services, such as web browsing, email, instant messaging, gaming, etc. It is also possible that these various Internet services are accessible via the TV 102. The TV 102, PC 104, and telephone 106 communicate with the data network 120, in order to receive network services (IPTV, VoIP, Internet access) delivered via the data network 120. The network services (IPTV, VoIP, Internet Access) may be packaged together and provided by a single service provider through the data network 120, or may be delivered separately through the data network 120. An access controller 108 controls access to and delivery of the network services delivered via the data network 120 to the TV 102, PC 104, and telephone 102. The access controller 108 may be provided, for example, in a router or wireless router which provides the devices 102, 104, and 106 a high speed connection to the data network 120. The access controller 108 may also be provided in one of the device, such as the PC 104 or the TV 102. The TV 102 can refer to an IPTV ready television or a set top box capable of receiving IPTV and playing IPTV content on a television.

The access controller 108 communicates with a database 110 storing a plurality of user profiles corresponding to a plurality of users. Each user profile contains access and delivery settings associated with a user for all of the network services. Access settings are settings which control what content of the network services can be accessed by a particular user. For example, access settings can be used for parental controls or to implement security levels in a business. According to an embodiment of the present invention, at least one user is considered an administrator, and access settings for all of the user profiles can only be set or adjusted by the administrator. Delivery settings are settings which control delivery preferences for the delivery of the network services. For example, delivery settings can include a preferred channel list for IPTV, a favorite web site list, a home page for web browsing, a buddy list for Instant messaging, speed dial settings for VoIP, contact lists for email addresses and telephone numbers, etc. The access controller 108 controls access and delivery of each of the network services (e.g., IPTV, Internet, VoIP) for a user based on the access settings and delivery settings specified in the user profile corresponding to the user. The database 110 may be stored in a router or the like connecting the devices 102, 104, and 106 to the data network. It is also possible that the database 110 may be stored in one of the devices, such as the PC 104 or the TV 102.

Although the access controller 108 and the database 110 are illustrated in FIG. 1 as part of the CPE 101, the present invention is not limited thereto. According to another embodiment of the present invention, an access controller and a database storing user profiles may be provided in a data network. For example, an access control and a database can be stored on a server of a service provider that provides a variety of network services, such as IPTV, VoIP, Internet access, etc. The database can store a plurality of user profiles associated with each customer account, and each user profile controls the content of the network services delivered to a user according to the access and delivery settings in the user profile corresponding to the user. In this embodiment, the user profiles can be provided as part of the service from the service provider.

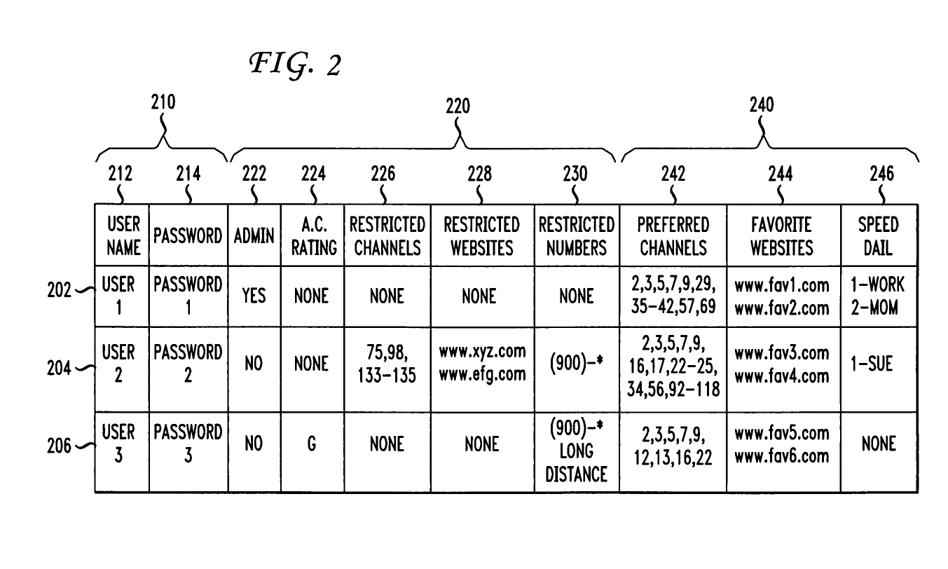

FIG. 2 illustrates exemplary user profiles 202, 204, and 206 stored in the database 110. As illustrated in FIG. 2, the database 110 stores a plurality of user profiles 202, 204, and 206 as records, and each user profiles 202, 204, and 206 has fields storing login settings 210, access settings 220, and delivery settings 240 for the user profiles 202, 204, and 206. The login settings 210 can include a user name 202 and a password associated with each user profile 202, 204, and 206. The login settings 210 are used to authenticate a user when logging in to one of the devices 102, 104, or 106 in order to receive a network service.

As illustrated in FIG. 2, the access settings 220 can include an administrator setting 222, an access control rating 224, a restricted channels list 226 for the IPTV service, a restricted web site list 228 for web browsing, and a restricted telephone number list 230 for the VoIP service. The administrator setting 222 indicates whether a user associated with a particular user profile 202, 204, or 206 is considered an administrator. A user who is an administrator can set and modify his/her own access settings 220 as well as the access settings 220 of the other users. A user who is not an administrator cannot change their own access settings 220. For example, in FIG. 2, user1 202 is an administrator, and can set and change the user settings for user1 202, user2 204, and user3 206. The access control rating 224 is a rating for a user that is used to control access to each of the network services available to that user in conjunction with predetermined rating systems used by each network service. For example, television programs and web sites both have ratings available for parents to gauge the age appropriateness of their content. The access control rating 224 allows an administrator to set the access control rating 224 in a user profile 202, 204, or 206 of a user in order to globally restrict access for that user to any content from any of the network services that is rated for an older audience then the access control rating 224. As illustrated in FIG. 2, user3 206 has an access control rating 224 of ‘G’, such that user3 206 can only receive content from any of the network services (i.e., IPTV, Internet, etc.) that is G rated (or less).

In addition to (or instead of) setting the access control rating 224 for each user profile 202, 204, and 206, the restricted channel list 226, restricted website list 228, and restricted telephone number list 230 can be used to provide the administrator greater control over access for the users to content of the network services. The restricted channel list 226 specifies IPTV channels that a user cannot access, the restricted website list 228 specifies websites that a user cannot access, and the restricted telephone number list specifies telephone numbers or groups of numbers that a user cannot access. For example, in FIG. 2, user1 has no restrictions for any of the network services. User2 204 cannot access the channels and websites respectively listed in the corresponding restricted channel list 226 and restricted website list 228, and cannot call ‘900’ numbers using the VoIP service. User3 206 has no channels or websites specified in the corresponding restricted channel list 226 and restricted website list 228 because, as described above, user3 206 is being restricted to content that is rated ‘G’. User3 206 cannot call ‘900’ numbers or any long distance numbers using the VoIP service. The access settings 220 illustrated in FIG. 2 are exemplary and various other access settings can also be included to give control to administrators (parents, business owners, etc.) over the access to various network services for each user.

As illustrated in FIG. 2, the delivery settings 240 can include a preferred channel list 242, a favorite websites list 244, and a speed dial list 246. The delivery settings for a user are all adjustable by that user, in order to allow a user to adjust the delivery preferences of the various network services. The preferred channel list 242 specifies favorite IPTV channels of a user. It is possible that only the channels specified in the preferred channel list 242 for a user are displayed in an on screen IPTV programming guide. Also, it is possible when a user switches IPTV channels using a channel up or channel down button on a remote control, the channels are switched only among the preferred channels. In this case, the user can manually enter a channel not on the preferred channel list to display that channel. The favorite websites list 244 specifies favorite websites of a user. This allows a user to quickly and easily navigate to the listed websites. The speed dial list 246 lists speed dials associated with a user for the VoIP service. Thus, each user can have his or her own speed dial settings, such that the speed dial settings vary based on which user is logged in to the VoIP service. The delivery settings 240 illustrated in FIG. 2 are exemplary and various other access delivery settings can also be included to allow each user to tailor delivery options for all available network services.

The access and delivery settings for multiple network services can be set via a user interface with any of the devices 102, 104, and 106 which are capable of receiving the various network services. According to an embodiment of the present invention, a graphic user interface is displayed on the TV 102 or the PC 104 to allow users to set or adjust the settings in their user profiles. If the graphic user interface is displayed on the TV 102, a user can use a remote control to set or adjust the settings. In this case, it is possible that the graphic user interface include a pop-up keyboard which is displayed on the television to allow a user to enter letters using the remote control. According to another embodiment of the present invention, a telephone interface, such as a voice recognition unit or a dual tone multi frequency (DTMF) recognition unit, can be used for a user to set or adjust the settings. In this case, a user can enter the settings via the telephone 106. As described above, an administrator can use a user interface on one of the devices 102, 103, and 106 in order to adjust access settings for any of the users, however, a user who is not and administrator cannot adjust any access settings including the access settings of his/her own user profile. Each user can use a user interface to adjust the delivery settings of his/her user profile.

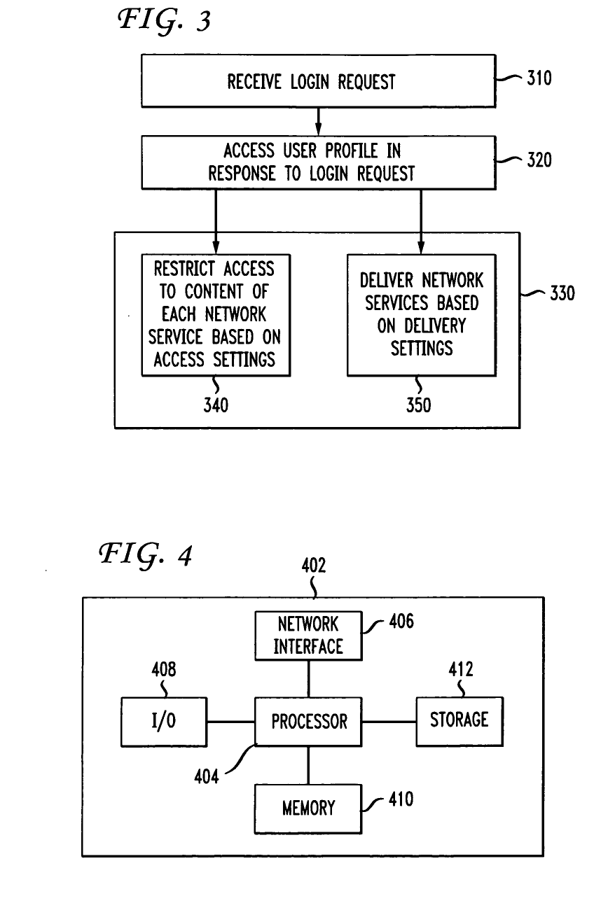

FIG. 3 illustrates a method of controlling multiple network services based on a user profile according to an embodiment of the present invention. Although not limited to the apparatus shown in FIG. 1, this method will be described while referring to FIGS. 1 and 3. As described above, a plurality of user profiles, each specifying access and delivery settings for a plurality of network services are maintained in the database 110. At step 310, the access controller 108 receives a login request. The login request can be received from any of the devices 102, 104, and 106 capable of receiving the network services. A user logs in by entering login information via one of the devices 102, 104, and 106. For example, the user can enter the user name and password using the remote control and a pop-up keyboard displayed on the TV 102, a keyboard attached to the PC 104, or DTMF digits of the telephone 106. The login information can then be transmitted to the access controller 108.

At step 320, the access controller 108 accesses a user profile in response to the received login request. The access controller 108 searches the database 110 for the user profile having login information which matches the login information input at one of the devices 102, 104, and 106.

At step 330, the access controller 108 controls access to and delivery of the plurality of network services based on the access and delivery settings of the user profile. In particular, at step 340 the access controller 108 restricts access to content in each of the network services based on the access settings in the user profile, and at step 350, the access controller 108 delivers the plurality of network services to the devices 102, 104, and 106 based on the delivery settings specified in the user profile. Thus, each user has a single user profile which controls access to and delivery of multiple to network services to one or more different devices.

The method described above may be implemented on a computer using well known computer processors, memory units, storage devices, computer software, and other components. A high level block diagram of such a computer is illustrated in FIG. 4. Computer 402 contains a processor 404 which controls the overall operation of the computer 402 by executing computer program instructions which define such operation. The computer program instructions may be stored in a storage device 412 (e.g., magnetic disk) and loaded into memory 410 when execution of the computer program instructions is desired. Thus, the access controller can be controlled by the processor 404 executing computer program instructions stored in the memory 410 and/or storage 412. The database storing the user profiles can also be stored in the storage 412. The computer 402 also includes one or more network interfaces 406 for communicating with other devices via a network. The computer 402 also includes input/output 408 which represents devices which allow for user interaction with the computer 402 (e.g., display, keyboard, mouse, speakers, buttons, etc.) One skilled in the art will recognize that an implementation of an actual computer will contain other components as well, and that FIG. 2 is a high level representation of some of the components of such a computer for illustrative purposes.

The foregoing Detailed Description is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention. Those skilled in the art could implement various other feature combinations without departing from the scope and spirit of the invention.

1. A method comprising:
maintaining a plurality of user profiles, each user profile specifying access and delivery settings for a plurality of network services;
receiving a login request;
accessing a user profile in response to the login request; and
controlling access to and delivery of the plurality of network services based on the access and delivery settings of the accessed user profile.

2. The method of claim 1, wherein said controlling step comprises:
restricting content of said plurality of network services based on the access settings of the user profile; and
delivering said plurality of network services based on the delivery settings of the user profile.

3. The method of claim 1, wherein said plurality of user profiles are associated with a plurality of users comprising at least one administrator.

4. The method of claim 3, further comprising:
determining whether a user associated with the accessed user profile is an administrator; and
if the user associated with the accessed user profile is an administrator, allowing the user to modify the access settings of each of the plurality user profiles and allowing the user to modify the delivery settings of the accessed user profile.

5. The method of claim 4, wherein if the user associated with the accessed user profile is not an administrator, preventing the user from modifying the access settings of any of the plurality of user profiles and allowing the user to modify the delivery settings of the accessed user profile.

6. The method of claim 1, wherein said receiving step comprises:
receiving a login request via at least one of a television, a computer, and a telephone.

7. The method of claim 1, wherein said plurality of network services comprises at least two of IPTV service, VoIP service, Internet service, and network gaming.

8. The method of claim 1, wherein said access settings comprise a list of restricted content for each of the plurality of network services.

9. The method of claim 1, wherein said access settings comprise an access control rating to control access to each of the plurality of network services based on a rating system of each of the plurality of network services.

10. The method of claim 1, where said plurality of network services includes at least IPTV service and Internet service, said access settings comprise parental controls for the IPTV service and the Internet service, and said delivery settings comprise IPTV channel preferences and web surfing preferences.

11. A system comprising:
means for maintaining a plurality of user profiles, each user profile specifying access and delivery settings for a plurality of network services;
means for receiving a login request;
means for accessing a user profile in response to the login request; and
means controlling access to and delivery of the plurality of network services based on the access and delivery settings of said user profile.

12. The system of claim 11, wherein said means for controlling comprises:
means for restricting content of said plurality of network services based on the access settings of the user profile; and
means for delivering said plurality of network services based on the delivery settings of the user profile.

13. The system of claim 11, wherein said plurality of user profiles are associated with a plurality of users comprising at least one administrator.

14. The system of claim 13, further comprising:
means for determining whether a user associated with a user profile is an administrator;
means for modifying the access and delivery settings of each of the user profiles; and
means for preventing a user that is not an administrator from modifying the access settings of the plurality of user profiles.

15. The system of claim 11, wherein said plurality of network services comprises at least two of IPTV service, VoIP service, Internet service, and network gaming.

16. The system of claim 11, where said plurality of network services includes at least IPTV service and Internet service, said access settings comprise parental controls for the IPTV service and the Internet service, and said delivery settings comprise IPTV channel preferences and web surfing preferences.

17. A system comprising:
a database storing a plurality of user profiles, each user profile specifying access and delivery settings for a plurality of network services;
an interface capable of inputting a user login request; and
a processor configured to access a user profile in the database in response to the user login request input via the interface and to control access to and delivery of the plurality of network services based on the access and delivery settings of the accessed user profile.

18. The system of claim 17, wherein said interface comprises a graphic user interface displayed on a television to allow a user to input login information via a remote control.

19. The system of claim 18, wherein said graphic user interface comprises a pop-up keyboard to allow a user to input letters using a remote control.

20. The system of claim 17, wherein said interface comprises a telephone interface to allow a user to input login information via a telephone, said telephone interface comprising at least one of a dual tone multi frequency (DTMF) recognition unit and a voice recognition unit.
